(19) United States
(12) Patent Application Publication
(10) Pub. No.: US 2024/0370913 A1
(43) Pub. Date: Nov. 7, 2024

(54) SYSTEMS AND METHODS FOR CUSTOMIZED OBJECT ENGRAVING

(71) Applicant: THE HILLMAN GROUP, INC, CINCINNATI, OH (US)

(72) Inventors: ROGER PALMER, Cave Creek, AZ (US); Ari Bennett, Walnut Creek, CA (US); David Wilkinson, Scottsdale, AZ (US); Michael J Schmidt, Gilbert, AZ (US); Jane Klein-Hageman, Queen Creek, AZ (US); Jim White, Phoenix, AZ (US)

(21) Appl. No.: 18/656,341

(22) Filed: May 6, 2024

Related U.S. Application Data
(60) Provisional application No. 63/464,524, filed on May 5, 2023.

(51) Int. Cl. G06Q 30/0601

(52) U.S. Cl. CPC G06Q 30/0621

(57) ABSTRACT

Implementations described and claimed herein provide systems and methods for object customization.

### CROSS-REFERENCE TO RELATED APPLICATIONS

The present application claims priority under 35 U.S.C. § 119 to U.S. Provisional Application No. 63/464,524, entitled “SYSTEMS AND METHODS FOR CUSTOMIZED OBJECT ENGRAVING” and filed on May 5, 2023, which is incorporated by reference in its entirety herein.

### FIELD

Aspects of the present disclosure relate generally to customized engraving of one or more objects and more particularly to generating a visual representation of a customized marking and engraving a selected object with the customized marking.

### BACKGROUND

Machines may be deployed at various locations, such as retail locations, amusement parks, travel facilities, and otherwise, to dispense objects with a selected inscription. However, such machines are often specifically tailored to a limited set of options for objects and inscriptions. Exacerbating these disadvantages, many of these machines are expensive to obtain and operate with complex tooling to hold and fixture the objects, making an expansion to other options impractical. As such, due to the limitations in object types and inscription options, many consumers elect to order customized products online. However, consumers are generally unable to inspect the object prior to customization. Thus, with many objects being non-returnable due to the customization, the consumer is vulnerable to receiving an object with inferior quality or that is otherwise undesired after waiting an extended period of time for the object to arrive via shipment.

It is with these observations in mind, among others, that various aspects of the present disclosure were conceived and developed.

### SUMMARY

Implementations described and claimed herein address the foregoing problems by providing systems and methods for customized object engraving. Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example customization system for object identification and customization.

FIG. 2 shows an example user device.

FIG. 3 shows an example engraving system.

FIG. 4 depicts an example laser system of the engraving system.

FIG. 5 illustrates varying focal planes of a laser beam.

FIGS. 6A and 6B show an example engraving system.

FIG. 7 illustrates example platen configurations.

FIG. 8 illustrates an example object.

FIG. 9 shows example operations for customized object engraving.

FIG. 10 depicts an example network environment for object identification and customization.

FIG. 11 shows an example computing system that may implement various systems and methods of the presently disclosed technology.

### DETAILED DESCRIPTION

Aspects of the presently disclosed technology relate to systems and methods for object identification and customization. A consumer may select or provide an object desired for customization. In doing so, the consumer is familiar with physical features of the object, including tactile features, material, and quality. In one aspect, a kiosk obtains the object and identifies one or more object features of the object. The kiosk determines marking features for a customized marking of the object. For example, the consumer may input or select the marking features. Based on the object features and the marking features, the kiosk generates customized marking parameters and a representation of the object with the customized marking. The consumer may view and otherwise interact with the representation prior to application of the customized marking. The kiosk applies the customized marking (e.g., through engraving) to the object using the customized marking parameters. In connection with application of the customized marking, the kiosk provides automatic orientation according to the object features, thereby eliminating a need for specialized fixtures to hold and orient each object type. The kiosk may provide a real time view of the customization process (e.g., through a window in the kiosk). The kiosk may monitor the customization process to provide assistance or troubleshooting as needed. Accordingly, the presently disclosed technology creates a consumer directed experience providing instant product gratification and entertainment, while facilitating ease of use. Through the elimination of specialized tooling for individual object types, a flexible, low-cost kiosk is provided to customize a myriad of objects and markings. Other advantages will be readily apparent from the present disclosure.

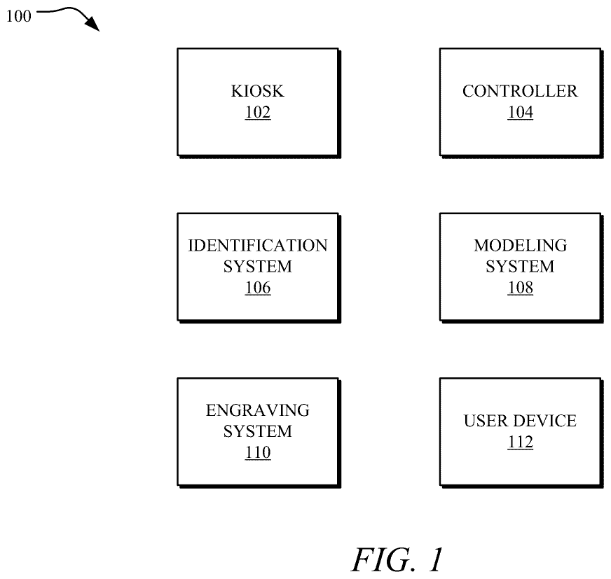

To begin a detailed description of an example customization system 100, reference is made to FIG. 1. In one implementation, the customization system 100 includes a kiosk 102, a controller 104, an identification system 106, a modeling system 108, an engraving system 110, and a user device 112, which may be integrated together or separate from each other in various configurations. In one example, the kiosk 102 includes the controller 104, the identification system 106, the modeling system 108, the engraving system 110, and the user device 112. In another example, the user device 112 is separate from and in communication with the kiosk 102. The controller 104, the identification system 106, and the modeling system 108 may be separate or integrated and similarly may be separate or part of the engraving system 110 and/or the user device 112. The controller 104 may be used to control various operations of the kiosk 102, and the user device 112 may be used to receive and present information to a consumer.

The kiosk 102 may include a housing enclosing various systems, devices, and components. The housing may include a door through which an object may be received for customization. The kiosk 102 is configured to provide smart customization of different objects, including, without limitation, pet products, collars, harnesses, leashes, tags, bowls, toys, balls, bones, chews, edible products, bandannas, jackets, hats, apparel, clothing, trackers, cases for computing devices, phone cases, pens, knives, labels, signs, patches, fabric, memorials, headstones, ornaments, key chains, and other structures. The objects may have varying materials, flexibility, softness, hardness, reflectivity, color, texture, and/or the like. Further, the objects may have a variety of three-dimensional shapes, including different combinations of curved, angled, and/or planar surfaces. The consumer may select one or more objects for customization. The object may be selected from various sources (e.g., available from a retailer, available within the housing of the kiosk 102, selected from objects owned by the consumer, etc.). The kiosk 102 may display isle options or options for shipping using the user device 112.

In one implementation, the identification system 106 identifies one or more object features of the object, which may include, without limitation, object type, object size, shape, material, flexibility, softness, hardness, reflectivity, color, texture, surface features, thermal conductivity, and/or the like. The user device 112 may include a sensor (e.g., a camera, scanner, etc.) configured to capture object information from which the object features are identified. The object information may include an identifier (e.g., a Universal Product Code (UPC) code, Quick Response (QR) code, etc.) that causes the identification system 106 to obtain the object features of the object. In another example, the object information may include sensor information, which may be used by the identification system 106 to determine the object features of the object.

In one implementation, the kiosk 102 includes a door that opens for receiving the object. For example, the door may automatically open or the user device 102 may prompt the consumer to open the door. The door may automatically lock and unlock to prompt the consumer to open the door and prevent the consumer from opening the door at various times during the process. The object is received through the door onto a platen of the engraving system 110. In one implementation, a projector (e.g., light emitting diodes (LEDs) project onto the platen directing the consumer to position and orient the object for application of the customized marking at a target area. The platen is configured to hold objects of various shapes and sizes with different object features.

The identification system 106 may detect the object positioned upon the platen. In one implementation, the identification system 106 identifies the object features of the object as described herein alternative to identification by the user device 112. In another implementation, the identification system 106 verifies the object features (e.g., using object information captured using a sensor) and compares the object features to those detected using the user device 112. Further, the identification system 106 obtains surface information of the object positioned on the platen using one or more sensors (e.g., cameras). Using the surface information, the modeling system 108 generates a model of one or more surfaces of the object. For example, the model may include a three-dimensional (3D) model of surfaces of the object. The object information and/or the surface information may further be used to detect any misalignment between a target area of the object and a laser of the engraving system 110.

In one implementation, the modeling system 108 provides automatic imaging of complex 3D surfaces (e.g., curved, angled, etc.) of the object with software compensation for 3D laser engraving. In one example, the modeling system 108 utilizes photogrammetry to define the one or more surfaces and a target area for engraving. More particularly, camera(s) may be used to build a 3D surface model of the object, including identification of the target area, through single or multiple point triangulation. In another example, laser scanning, in which a laser source generates a laser beam that when imaged by a camera provides surface information, may be used to generate the 3D model. Similarly, a structured light 3D scanner may measure the 3D shape of the object using projected light patterns imaged by the camera to generate the 3D model.

A representation of the object is generated and presented using the user device 112. The representation may include the object positioned on the platen and include a representation of the target area on the representation of the object. The user device 112 may prompt the consumer to input user information, such as a pet name, QR code for pet identification, phone number, reward if lost, an address, and/or the like. The user information may form part of a customized marking in some instances.

The identification system 106 determines marking features for the customized marking of the object. For example, the consumer may input or select the marking features using the user device 112. The customized marking may include, without limitation, lettering, codes (e.g., QR code), color, images, photographs, logos, patterns, designs, and/or the like. In one example, the user device 112 may present options for selection to customize a stock image. The options may include animal type, breed, and colors, for example, to generate a customized image of a pet. The customized marking may be visible, ultraviolet (UV), UPC, near field, and/or the like. The modeling system 108 generates a customized representation of the object with the customized marking applied. The customized representation may be displayed as a 3D model using the user device 112. Additionally or alternatively, the customized representation may include a low power targeting laser (e.g., red or green) or a similar projector to display the customized marking on the target area of the object positioned on the platen.

The consumer may view and otherwise interact with the representation prior to application of the customized marking. For example, the consumer may view the representation of the customized object from various angels and change, cancel, and/or approve application of the customized marking. In this manner, the consumer can understand the finished product before committing to the customization process. Upon receipt of input approving the customization, the customized marking is applied to the object. The approval may be captured using the user device 112, based on a detection of the door to the kiosk 102 closing, and/or the like.

Based on the object features and the marking features, customized marking parameters are generated. More particularly, application of the customized marking may vary depending on the different object features, the marking features, and/or configuration of the engraving system 110. For example, the engraving system 110 may include one or more lasers, such as a carbon dioxide (CO₂) laser, fiber laser, Master Laser and Optical Amplifier (MOPA) laser, Ultraviolet (UV) laser, and/or the like, for applying the customized marking. In this manner, while referred to as an engraving system and with engraving referenced throughout, it will be appreciated that various manners in which a marking may be applied to an object are contemplated (e.g., engraving, embossing, etching, painting, etc.).

The customized marking parameters may include optimum laser settings, determined as a function of the object features and the marking features. For example, the customized marking parameters may include a selection of a marking laser where the engraving system 110 includes a plurality of laser heads. The customized marking parameters may further include platen configuration, object orientation, camera orientation, laser focal depth, and/or the like.

The engraving system 110 applies the customized marking to the object using the customized marking parameters. In one implementation, the engraving system 110 utilizes artificial intelligence based optical recognition of the surfaces of the object and optimal location with auto focus and following for precision engraving on the particular surfaces of the object, which may vary dramatically from other objects. More particularly, the identification system 106 uses data captured by one or more sensors to orient the target area and compensate in three dimensions for the object. The modeling system 108 builds the 3D image of the object and orientation using a plurality of sensors and/or laser scanning. During engraving, the engraving system uses a z-axis motor configured to move upwards and downwards along a z-axis to set an optimal focal distance for marking using a laser, thereby compensating for objects having varying sizes. One or more x-y motors permit the laser to engrave over an entirety of a surface area of the platen. In this manner, the kiosk 102 is orientation and location agnostic to the object, such that the object may be engraved independent of where the object is positioned on the platen and/or oriented on the platen. In this manner, the kiosk may engrave a plurality of objects and/or target areas. The z-axis motor may also compensate for objects having a large thickness relatively to the platen (e.g., a bowl). Additionally, the engraving system 110 may include a high foal depth less (e.g., >+/1 mm) to 3D compensation of the object, thereby providing increased flexibility in marking curved surfaces. For complex surfaces, the laser head may be moved along the z-axis. The modeling system 108 compensates for possible distortion of the engraving due to the 3D surface of the object.

The kiosk 102 may include a transparent surface (e.g., window) and/or real time view of the object (e.g., live camera feed) or the representation of the object to view the engraving process in real time as the customized object is created. Examples of a customized object with the customized marking include, without limitation: a surface (e.g., on a phone case) with a 3D customized printing effect; engraved stickers or patches for pets; engraved tags or pet objects with laser graphics, patterning, and/or laser color; engraved harnesses; laser patterning of knives, tools, and/or hardware; engraved urns with laser graphics, patterning, and/or laser color; engraved signs; engraved tracking tags (e.g., pet tracking tags); engraved labels; and/or the like. Upon conclusion of the engraving process, the door to the kiosk 102 may automatically open or the user device 112 may prompt the consumer to open the door.

The kiosk 102 may monitor the customization process to provide assistance or troubleshooting as needed. For example, the sensors may track progress of the customization process and identify any issues. The kiosk 102 may respond to the issues for example, by automatically correcting the issue, dispatching assistance, or prompting the consumer using the user device 102 to take one or more actions.

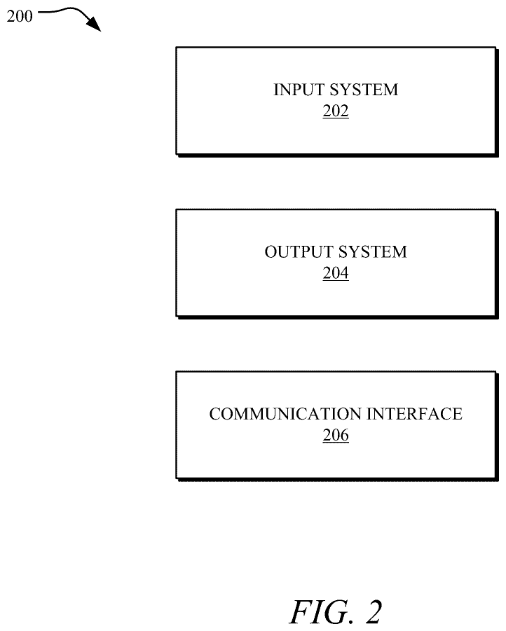

Turning to FIG. 2, an example user device 200 is shown. The user device 200 may be applicable to the user device 112. In some implementations, the user device 200 is separate from the kiosk 102. In other implementations, the user device 200 is integrated into the kiosk 102. The user device 200 includes an input system 202, an output system 204, and a communication interface 206. The user device 200 may include the controller 106. The user device 200 may be a personal computer, a workstation, smartphone, tablet, wearable, and/or the like. The user device 200 may be used to control and otherwise communicate with the kiosk 102 using the communication interface 206. For example, the communication interface 206 may communicate with the kiosk 102 using a wired or wireless (e.g., Bluetooth, WiFi, etc.) connection. The communication interface 206 may further be used to communicate with other computing devices via wired or wireless connection. For example, the communication interface 206 may be used to communicate with a retail device that captured payment for the object and/or engraving. Alternative to communication with the retail device, the consumer may purchase the object and engraving and receive a code for input using the user device 200 to initiate the customization process. The user device 200 may validate the code using data accessed via one or more computing devices in communication with the user device 200 via the communication interface 206.

The input system 202 may include one or more input devices configured to capture various forms of user input. For example, the input system 202 may be configured to capture visual input (e.g., information provided via gesture), audio input (e.g., information provided via voice), tactile input (e.g., information provided via touch, such as via a touch-sensitive display screen (“touchscreen”), etc.), device input (e.g., information provided via one or more input devices), and/or the like from the consumer. Similarly, the output system 204 may include one or more output devices configured to present output data in various forms, including visual (e.g., via display, projection, etc.), audio, and/or tactile. The input system 202 and/or the output system 204 may include various software and/or hardware for input and output. The input system 202 and/or the output system 204 may be integrated into one system, in whole or part, or separate. For example, the input system 202 and/or the output system 204 may be provided in the form of a touchscreen of the kiosk 102, a smartphone, and/or the like. In some implementations, the input system 202 and/or the output system 204 provide an interactive interface, thereby facilitating interactions with the consumer during the customization process.

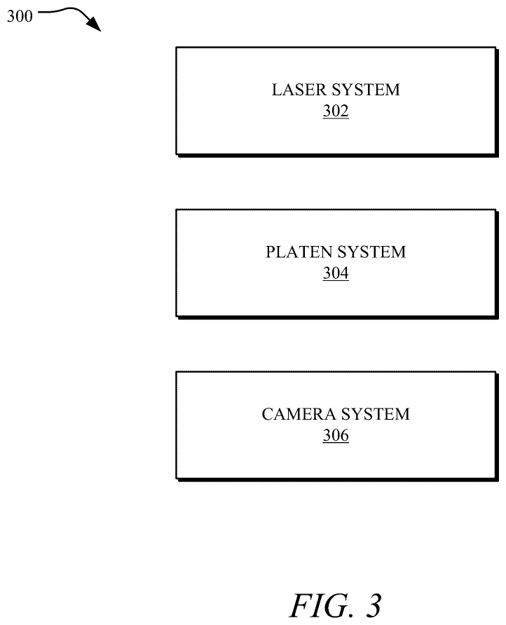

Referring to FIG. 3, example systems 300 of the engraving system 110 are shown. The systems 300 may include a laser system 302, a platen system 304, and a camera system 306.

The laser system 302 may include one or more laser heads, including but not limited to, a fiber laser head, CO₂ laser head, UV laser head, MOPA laser head, and/or the like. The laser system 302 may have a plurality of rotating laser heads for optimal marking. For example, the fiber laser head ma be used for engraving metal, plastics, and/or fabric with fiber laser additives or fabric with a defined target area. The CO₂ laser head may be used for engraving fabrics, bone, wood, plastics, and/or the like. The platen system 304 may include various platen configurations, including but not limited to, flat platens, slotted platens (e.g., for a collar or leash), platens with a dimple (e.g., for balls), and platens with a side in holder (e.g., for bowls). The camera system 306 may include one or more camera, such as visible wavelength cameras, infrared cameras, UV camera, and/or the like. The cameras may be configured to capture 2D images (e.g., RGB image, grayscale image, thermal image, UV image, etc.) or 3D images (e.g., point clouds).

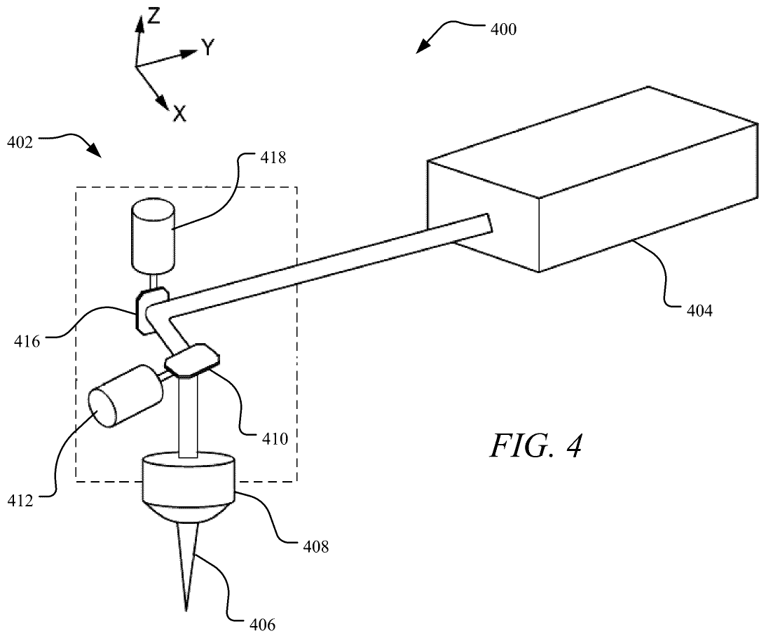

FIG. 4 depicts an example laser system 400, which may be applicable to the laser system 302 and/or the engraving system 110. In one implementation, a laser head, such as those discussed herein, includes a laser beam control assembly 402. The laser beam control assembly 402 may include galvanometer heads 418 and 412 and optical elements 416, 410, and 408. The galvanometer heads 418 and 412 may be configured to rotate the optical elements 416 and 410 about the z-axis and y-axis, respectively.

A laser generator 404 may emit laser beam 406 directed towards the laser beam control assembly 402. The optical elements 416, 410, and 408 may include one or more of mirrors, lenses, prisms, or any other type of optical device capable of directing the laser beam 406. For example, the optical element 416 may be configured to direct the laser beam 406 emitted by the laser generator 404 towards the optical element 410, which in turn may be configured to direct the laser beam 406 towards the optical element 408. The optical element 408 may be configured to focus the laser beam 406 and generate a laser spot having a size or diameter based on a vertical position of the laser head relative to target area of the object. The galvanometer heads 418 and 412 may allow laser beam 406 to move continuously along one or more curved surface instead of moving in raster fashion (e.g., along rows and columns). This may allow the laser system 400 to generate the customized marking using vector marking, raster marking, and/or the like. The laser system 400 may be configured to generate smoother and sharper edges as opposed to the pixelated edges. Additionally, such vector marking may allow the customized marking to be generated on the object at a significantly faster rate. This in turn may allow the laser beam 406 to be impinged on the object multiple times to generate a more precision marking on the object.

As such, the laser system 400 achieves laser marking on curved workpieces more accurately, without defocusing during processing, and handle complex curved surfaces freely. The three-dimensional dynamic laser marking control of the laser system 400, including a galvanometer scanner in the galvanometer heads 418 and 412, controls the laser beam 406 to apply the customized marking any three-dimensional curved surface of the object to realize customized processing of various complex surface materials. The galvanometer scanner may move the laser beam in X and Y directions of a marking field, with the galvanometer heads 418 and/or 412 in the X, Y, and Z directions to enlarge the marking field within three-dimensions.

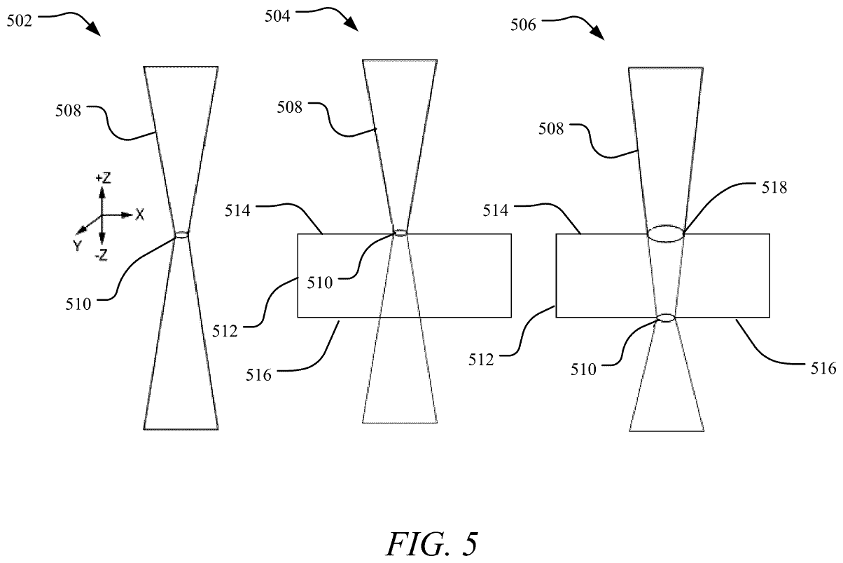

FIG. 5 illustrates varying focal planes of a laser beam. For example, focal plane representation 502 illustrates a laser beam 508 emitted by the laser generator 404. As illustrated in the focal plane representation 502, the engraving machine 110 may include one or more optical elements (e.g., lenses, mirrors, prisms) that may be configured to focus the laser beam 508 to converge towards a laser spot 510 having a predetermined diameter. As also illustrated in the focal plane representation 502, the laser beam 508 may diverge (e.g., increase in diameter) in the negative z-direction away from the laser spot 510.

Focal plane representations 504 and 506 illustrate exemplary configurations for focusing the laser beam 508 on an object 512 to be engraved. As illustrated in the focal plane representation 504, the laser head may be vertically positioned to focus the laser beam 508 so that the laser spot 510 having its smallest diameter may be formed on an upper surface 514 of the object 512 (e.g., when the upper surface 514 lies on a focal plane of the laser beam 508). In contrast, as illustrated in the focal plane representation 504, the laser head may be vertically positioned to focus the laser beam 508 so that the laser spot 510 having its smallest diameter may be formed on a lower surface 516 of the object 512 (e.g., when lower surface 104 lies on a focal plane of laser beam 508). In this condition, the laser beam 508 may not be in focus on the upper surface 514 of the object 512. When the laser beam 508 is not in focus on the upper surface 514, the energy of the laser beam 508 is dispersed. The amount of dispersion of the energy (or an amount by which the laser beam 508 is out of focus relative to upper surface 514) may be determined based on absorption properties of the material of the object 512. Thus, a larger laser spot 518 may be formed on the upper surface 514 of the object 512.

The laser head may be variably positioned to generate laser spots of different diameters (e.g., 510, 518) on the upper surface 514 of the object 512. The vertical position of the laser head, and therefore, a size of the laser spot 518 may be determined based on a material of the object 512. The vertical position of the laser head and, therefore, a size of the laser spot 518 may additionally or alternatively be determined based on the customized marking. For example, a relatively larger size of laser spot 518 (e.g., a spot that is more out of focus) may be desirable when engraving certain graphical features (e.g., images, icons, QR codes etc.) on the object 512 as opposed to when engraving textual matter on the object 512. If the object 512 is has one or more curved surfaces, a vertical position of the laser head may be adjusted during the engraving process to ensure a same size of laser spot 510 or 518 is used over some or all portions of the object 512. In some examples, when the radius of curvature of the object 512 is greater than a predetermined threshold (e.g., ±2 mm), a vertical position of laser head may not be changed, whereas when the radius of curvature of the object 512 is less than the predetermined threshold, the vertical position of laser head may be adjusted to account for the curvature of the object 512.

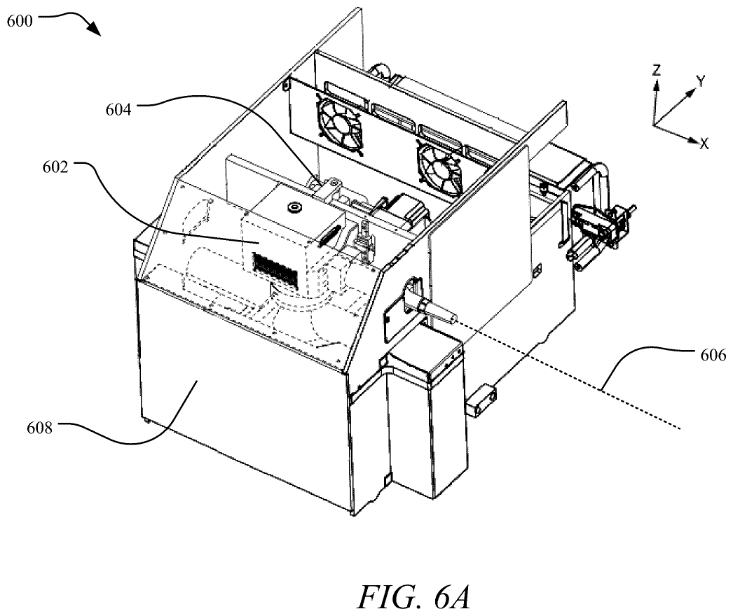

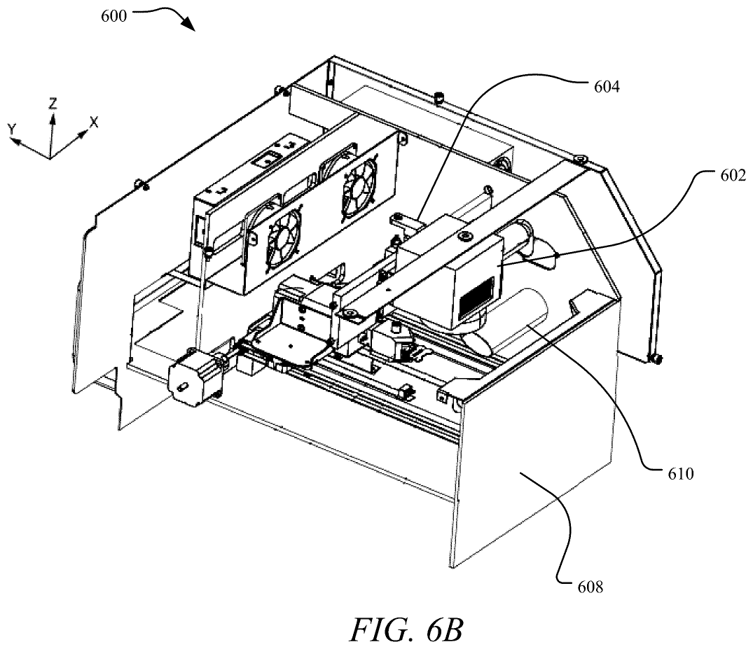

Turning to FIGS. 6A and 6B, an example engraving system 600 is shown, which may be applicable to the engraving system 110. In one implementation, the engraving system 600 includes a laser head 602 housing a camera and galvanometer and configured to generate a laser beam 606, a z-axis stepper motor 604, a door 608, and an extraction system 610.

The z-axis stepper motor 604 is configured to move the laser head 602 along a z-axis for laser focus and position. Stated differently, during engraving, the z-axis stepper motor 604 move upwards and downwards along the z-axis to set an optimal focal distance for marking using the laser beam 606, thereby compensating for objects having varying sizes. One or more x-y motors permit the laser beam 606 to engrave over an entirety of a surface area of the platen. In this manner, the object may be engraved independent of where the object is positioned on the platen and/or to engrave a plurality of objects and/or target areas. The z-axis stepper motor 604 may also compensate for objects having a large thickness relatively to the platen. Additionally, the laser head 602 may provide a high foal depth less (e.g., >+/1 mm) to 3D compensation of the object, thereby providing increased flexibility in marking curved surfaces. For complex surfaces, the laser head 602 may be moved along the z-axis. The extraction system 610 may include one or more fans and/or vacuum pumps for removal and filtering of any fumes. A HEPA Filter may be used to remove particles, and a carbon filter may be used to remove odors.

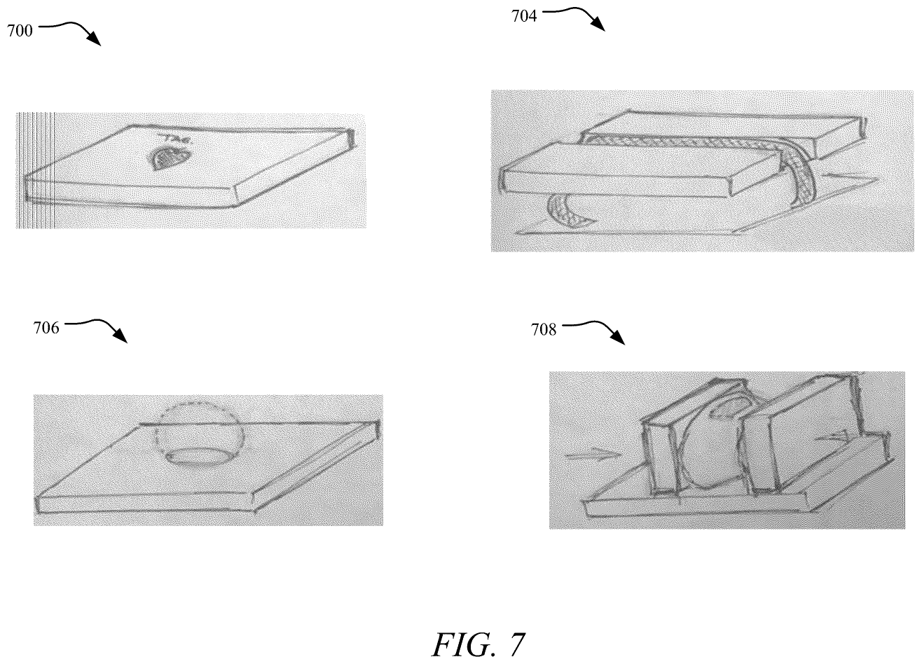

In one implementation, a misalignment of the target area of the object relative to the z-axis may be detected and adjusted using the z-axis stepper motor 604 and/or the other motors accordingly. Additional mechanisms may be utilized for orientation and to compensate for possible distortion of the customized marking due to the 3D surface of the object. For example, as can be understood from FIG. 7, various platen configurations 700-708 may be used to orient objects. In some implementations, the platen configurations 700-708 are interchangeable and selectable based on the object features. More particularly, a single universal platen may be provided as a simple plate and/or vacuum plate for holding the object. Multiple platens may be deployed in the engraving system 110 with a specific platen being identified based on the object features and/or marking features. Software of the kiosk 102 may compensate for curved, angled, and/or complex surfaces of the object as described herein.

In one example, the platen configuration 700 is a flat platen for placing objects with relative stability and/or one or more planar surfaces (e.g., tags, phone cases, etc.). The platen configuration 702 is a platen with a grove for receiving flexible objects (e.g., collars, leashes, etc.). A strap may be used to stabilize the object. The platen configuration 704 is a platen with a dimple for receiving round or otherwise contoured objects (e.g., a ball). The platen configuration 706 is a platen with movable shelves defining a receiving area with a customized size. The shelves are automatically set to a width of the object relative to the laser head. The identification system 104 may automatically identify the target area of the object relative to they-axis using artificial intelligence.

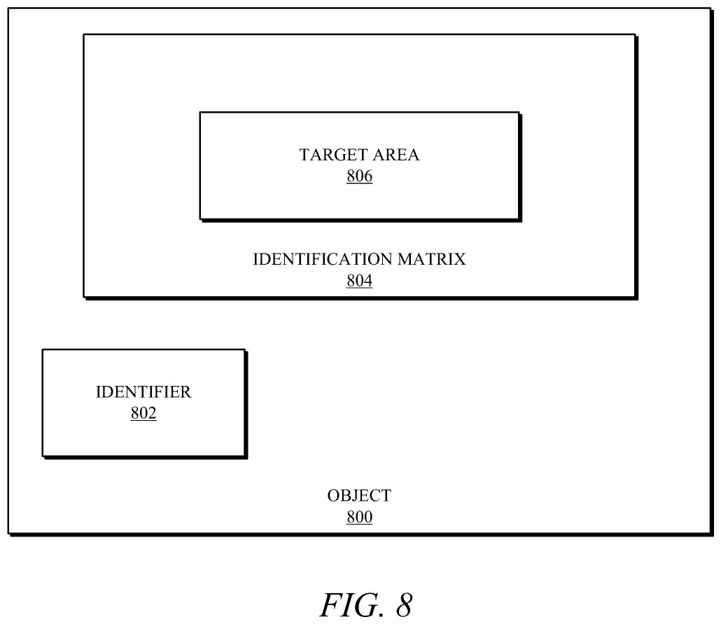

Turning to FIG. 8, an example object 800 is shown configured to facilitate target area orientation and/or identification. The object 800 may include an identifier 802 and/or an identification matrix 804 and a target area 806. The object 800 may be packaged in a packaging system configured to orient the target area 806 in a direction to facilitate modeling and/or engraving of the object 800. For example, the packaging system may orient the target area 806 in a direction towards the laser beam 606 and flatten the target area 805 for optimal engraving. Similarly, the packaging system may position the identifier 802 and/or the identification matrix 804 for identification (e.g., in a direction towards the sensors. In this manner, the packaging system may flatten the object 800, define the target area 806, and facilitate identification.

The object 800 may be identified using the identifier 802 as described herein. For example, the identifier 802 may be a UPC code, a QR code, and/or the like. The target area 806 may be identified using the identification matrix 804, which may be based on a surface of the object and/or an artificial matrix disposed on the surface of the object. For example, the surface of the object 800 may include a uniform pattern (e.g., a fabric pattern). The uniform pattern may be used to optically map the 3D shape of various surfaces (e.g., curved, angled, planar, etc.). Similarly, if the object 800 does not include a unfirm pattern, the artificial matrix may include an invisible (e.g., UV) dot matrix on the surface. The identification matrix 804 may be used to calculate surface curvatures and shapes. As such, the shape of the object 800 may be understood by visible or invisible patterns and the target area 806 may be defined accordingly. The object 800 may further include cutout windows in packaging to define the target area 806.

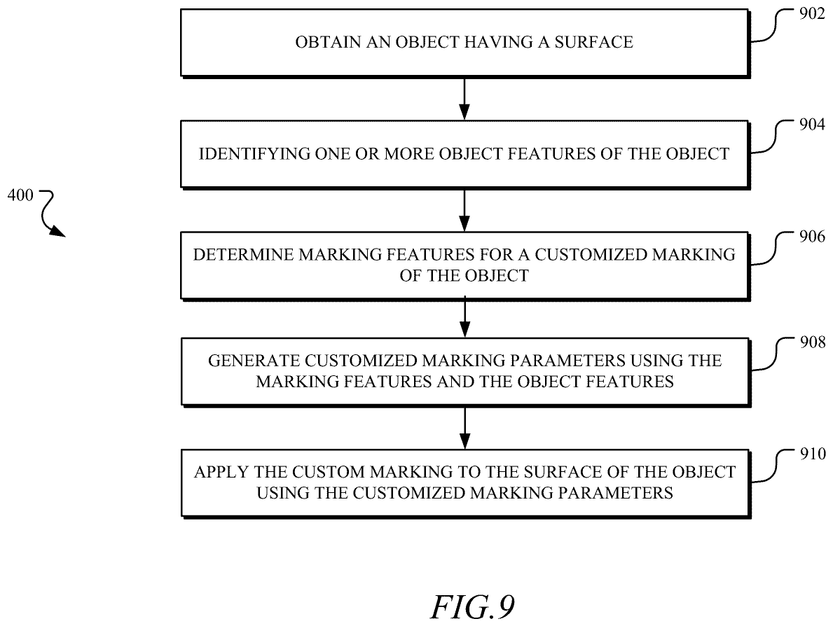

FIG. 9 shows example operations 900 for customized object engraving. In one implementation, an operation 902 obtains an object having a surface, and an operation 904 identifies one or more object features of the object. An operation 906 determines one or more marking features for a customized marking of the object. An operation 908 generates customized marking parameters using the one or more marking features and the one or more object features, and an operation 910 applies the custom marking to the surface of the object using the customized marking parameters.

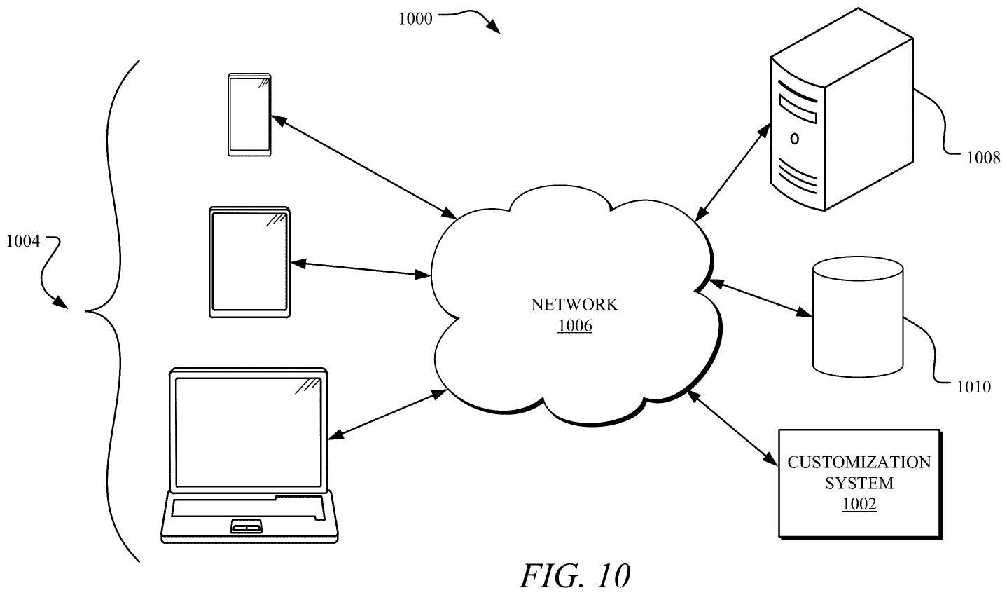

For a detailed description of an example network environment 1000 for providing object customization, reference is made to FIG. 10. In one implementation, a consumer accesses and interacts with customization system 1002 (e.g., the kiosk 102) using a user device 1004 for customizing an object via a network 1006.

The user device 1004 is generally any form of computing device capable of interacting with the network 1006, such as a personal computer, terminal, workstation, portable computer, mobile device, smartphone, tablet, multimedia console, etc. The network 1006 is used by one or more computing or data storage devices (e.g., one or more databases 1010 or other computing units described herein) for implementing the customization system 1002 and other services, applications, or modules in the network environment 1000.

In one implementation, the network environment 1000 includes at least one server 1008 hosting a website or an application that the user may visit to access the customization system 1002 and/or other network components. The server 1008 may be a single server, a plurality of servers with each such server being a physical server or a virtual machine, or a collection of both physical servers and virtual machines. In another implementation, a cloud hosts one or more components of the network environment 1000. The user devices 1004, the server 1008, and other resources connected to the network 1006 may access one or more other servers to access to one or more websites, applications, web services interfaces, storage devices, computing devices, or the like that are used for object customization. The server 1008 may also host a search engine that the customization system 1002 uses for accessing, searching for, and modifying object data, representations of objects, marking features, and/or the like, as described herein. For example, a consumer may perform customization online via the network environment 1000 using the user device 1004, which is communicated to the customization system 1002 for execution of engraving.

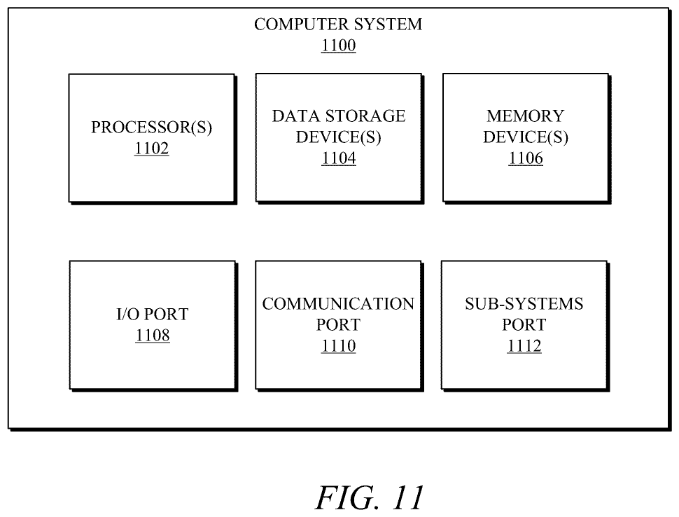

Referring to FIG. 11, a detailed description of an example computing system 1100 having one or more computing units that may implement various systems and methods discussed herein is provided. The computing system 1100 may be applicable to the various aspects of the customization system 100 and/or network devices or units. It will be appreciated that specific implementations of these devices may be of differing possible specific computing architectures not all of which are specifically discussed herein but will be understood by those of ordinary skill in the art.

The computer system 1100 may be a computing system is capable of executing a computer program product to execute a computer process. Data and program files may be input to the computer system 1100, which reads the files and executes the programs therein. Some of the elements of the computer system 1100 are shown in FIG. 11, including one or more hardware processors 1102, one or more data storage devices 1104, one or more memory devices 1106, and/or one or more ports 1108-1112. Additionally, other elements that will be recognized by those skilled in the art may be included in the computing system 1100 but are not explicitly depicted in FIG. 11 or discussed further herein. Various elements of the computer system 1100 may communicate with one another by way of one or more communication buses, point-to-point communication paths, or other communication means not explicitly depicted in FIG. 11.

The processor 1102 may include, for example, a central processing unit (CPU), a microprocessor, a microcontroller, a digital signal processor (DSP), and/or one or more internal levels of cache. There may be one or more processors 1102, such that the processor 1102 comprises a single central-processing unit, or a plurality of processing units capable of executing instructions and performing operations in parallel with each other, commonly referred to as a parallel processing environment.

The computer system 1100 may be a conventional computer, a distributed computer, or any other type of computer, such as one or more external computers made available via a cloud computing architecture. The presently described technology is optionally implemented in software stored on the data stored device(s) 1104, stored on the memory device(s) 1106, and/or communicated via one or more of the ports 1108-1112, thereby transforming the computer system 1100 in FIG. 11 to a special purpose machine for implementing the operations described herein. Examples of the computer system 1100 include personal computers, terminals, workstations, mobile phones, tablets, laptops, personal computers, multimedia consoles, gaming consoles, set top boxes, and the like.

The one or more data storage devices 1104 may include any non-volatile data storage device capable of storing data generated or employed within the computing system 1100, such as computer executable instructions for performing a computer process, which may include instructions of both application programs and an operating system (OS) that manages the various components of the computing system 1100. The data storage devices 1104 may include, without limitation, magnetic disk drives, optical disk drives, solid state drives (SSDs), flash drives, and the like. The data storage devices 1104 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 1106 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 1104 and/or the memory devices 1106, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 1100 includes one or more ports, such as an input/output (I/O) port 1108, a communication port 1110, and a vehicle sub-systems port, for communicating with other computing, network, or vehicle devices. It will be appreciated that the ports 1108-1112 may be combined or separate and that more or fewer ports may be included in the computer system 1100.

The I/O port 1108 may be connected to an I/O device, or other device, by which information is input to or output from the computing system 1100. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 1100 via the I/O port 1108. Similarly, the output devices may convert electrical signals received from computing system 1100 via the I/O port 1108 into signals that may be sensed as output by a human, such as sound, light, and/or touch. The input device may be an alphanumeric input device, including alphanumeric and other keys for communicating information and/or command selections to the processor 1102 via the I/O port 1108. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 1100 via the I/O port 1108. For example, an electrical signal generated within the computing system 1100 may be converted to another type of signal, and/or vice-versa. In one implementation, the environment transducer devices sense characteristics or aspects of an environment local to or remote from the computing device 1100, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 1100, such as, physical movement of some object (e.g., a mechanical actuator), heating or cooling of a substance, adding a chemical substance, and/or the like.

In one implementation, a communication port 1110 is connected to a network by way of which the computer system 1100 may receive network data useful in executing the methods and systems set out herein as well as transmitting information and network configuration changes determined thereby. Stated differently, the communication port 1110 connects the computer system 1100 to one or more communication interface devices configured to transmit and/or receive information between the computing system 1100 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 1110 to communicate one or more other machines, either directly over a point-to-point communication path, over a wide area network (WAN) (e.g., the Internet), over a local area network (LAN), over a cellular (e.g., third generation (3G) or fourth generation (4G) or fifth generation (5G)) network), or over another communication means. Further, the communication port 1110 may communicate with an antenna for electromagnetic signal transmission and/or reception. In some examples, an antenna may be employed to receive GPS data to facilitate determination of a location of a machine, vehicle, or another device.

The sub-systems port 112 may be used for communicating with one or more systems related to object identification and customization, such as to control an operation of the kiosk 102 and/or exchange information between the computer system 1100 and one or more sub-systems of the kiosk 102.

In an example implementation, object customization data and other modules and services for operating various aspects of the customization system 100 may be embodied by instructions stored on the data storage devices 1104 and/or the memory devices 1106 and executed by the processor 1102. The computer system 1100 may be integrated with or otherwise form part of the kiosk 102. In some instances, the computer system 1100 is a portable device that may be in communication and working in conjunction with various systems or sub-systems of the kiosk 102.

The system set forth in FIG. 11 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for object customization, the method comprising:
identifying one or more object features of an object, the object having a surface;
determining marking features for a customized marking of the object;
generating customized marking parameters using the marking features and the object features; and
causing the custom marking to be applied to the surface of the object using the customized marking parameters.

2. The method of claim 1, wherein the object is positioned at an arbitrary orientation on a platen prior to application of the custom marking.
